(19) United States
(12) Patent Application Publication
(10) Pub. No.: US 2026/0320207 A1
(43) Pub. Date: Oct. 15, 2026

(54) PERSONAL HELPER BOT SYSTEM HAVING A SECURE ORCHESTRATION ENGINE FOR EXECUTING USER DIRECTIVES BY WAY OF BOT PROCEDURES AND LINK-SCOPED AUTHORIZATION

(71) Applicant: Bertrand Barrett, Lawrenceville, GA (US)

(72) Inventor: Bertrand Barrett, Lawrenceville, GA (US)

(21) Appl. No.: 19/559,923

(22) Filed: Mar. 6, 2026

Related U.S. Application Data
(63) Continuation-in-part of application No. 18/595,370, filed on Mar. 4, 2024, now abandoned.

(51) Int. Cl. G06F 21/62; G06F 9/50

(52) U.S. Cl. CPC G06F 21/62; G06F 9/5016

(57) ABSTRACT

A secure orchestration engine receives structured user intent from a helper-agent interface and generates a machine-readable recipe specifying BOT participants, sequencing, and per-link credentials. BOT security entitlements define rights, restrictions, and levels of security governing BOT identity, authorized capabilities, and data access. For each recipe link, the engine derives ephemeral key pairs in volatile memory and computes a shared session key incorporating an intent hash. Each BOT-to-BOT interaction is authenticated, entitlement-validated, and purpose-validated. Key material is zeroized immediately after execution. Mismatches in intent validation trigger automatic revocation and quarantine. The system extends entitlement-based security by introducing intent-bound validation as an additional level of security.

### CROSS REFERENCE TO RELATED APPLICATIONS

This application is a Continuation-in-Part of U.S. Patent Provisional Application Ser. No. 62/011,552 (filed Jun. 12, 2014), U.S. Non-provisional application Ser. No. 14/736,265 (filed Jun. 11, 2025—published as US 2016/0044380 A1), Ser. No. 16/454,031 (filed Jun. 26, 2029—published as US 2020/0410391 A1) and Ser. No. 18/595,370 (filed Mar. 4, 2024—published as US 2024/0346096 A1), entitled “Personal Helper BOT System with Example Applications in Genealogy and Music Playlist Curation,” which claims priority to U.S. application Ser. No. 16/454,031, filed Jun. 26, 2019, titled “Personal Helper BOT System;” which claims priority to U.S. application Ser. No. 14/736,265, filed Jun. 11, 2015. Accordingly, the present disclosure is intended to preserve continuity with the earlier disclosures by using consistent terminology, architectures and embodiments, while further describing improved security and authentication mechanisms for BOT orchestration and procedure execution. Nothing herein shall be construed as disclaiming any earlier disclosed embodiments.

### FIELD OF THE INVENTION

The present invention relates generally to computerized personal helper systems, digital libraries, and automated BOT architectures. More particularly, the present invention relates to systems and methods for computer security in distributed BOT architectures, specifically orchestration engines that generate and execute intent-bound recipes with ephemeral authentication and multi-level security controls.

### BACKGROUND OF THE INVENTION

Applicant's earlier patent applications describe a personal helper BOT that interprets input, derives intent, and coordinates activity across reusable BOT libraries. Personal helper systems can be configured to receive user directives, interpret user intent, and execute tasks by coordinating one or more software agents, sometimes referred to herein as “BOTs.” Such BOTs may include, without limitation, BOTs that retrieve information, organize information, schedule events, interact with third-party services, and prepare user-visible outputs such as documents, lists, charts, notifications, and recommendations.

In known systems, a user directive may be expressed in conversational form by way of a user interface, including an avatar embodiment. A coordination element can interpret the directive and synthesize a procedure comprising a plurality of action steps that invoke one or more BOTs. In some embodiments, such invocation may occur by way of local calls, remote procedure calls, RESTful calls, and/or utilization of application programming interfaces (APIs).

As personal helper systems become capable of executing more complex procedures involving multiple BOTs and external services, it becomes increasingly important to confirm that a user is authorized, that a requested action is consistent with the user's directive, that authorization does not persist beyond what is required for the procedure, and that communications between BOTs and services are protected from misuse, replay, and unintended persistence.

Accordingly, there exists a need for improved security in BOT procedure execution in a manner that preserves the original Helper BOT architecture and remains compatible with existing embodiments including avatars, BOT libraries, case-based learning, and digital library architecture.

### SUMMARY OF THE INVENTION

The disclosed inventive system, in general, is a computer security and orchestration control mechanism that constrains tool-using automation through (i) intent capture and hashing, (ii) dependency-graph-based execution, (iii) per-link ephemeral authorization, and (iv) verification/audit linkage between authorization and execution. Morfe specifically, the present invention provides a personal helper BOT system comprising a user interface, a coordination element, and a plurality of BOTs, wherein the coordination element is configured to interpret a user directive, synthesize a procedure in response to the user directive, and execute said procedure by invoking one or more BOTs. Further, a secure orchestration engine converts structured intent into a machine-readable recipe defining ordered links between BOTs. Security entitlements establish baseline permissions and levels of security associated with BOT identities and operational constraints. For each link, the engine derives ephemeral credentials, performs entitlement validation, and validates an intent hash derived from structured intent. Intent validation provides an additional level of security beyond identity-based entitlement checks by verifying that execution corresponds to authorized workflow purpose. Execution proceeds recursively across recipe links until completion, after which credentials are revoked and proof of execution is recorded.

In one embodiment, the user interface comprises a personal assistant in the form of a customizable avatar (now also referred to as a Helper Agent) that receives user directives and delivers results.

In another embodiment, the coordination element generates a machine-readable procedure description (each “recipe”) describing ordered interactions (“links”) between BOTs and executes said recipe to produce the requested work product or service.

In further embodiments, the system incorporates improved security by establishing, for each link in a recipe, link-scoped authorization material that is generated when needed and destroyed after use. Such authorization is bound to the user directive and to the link being executed, reducing the risk of credential reuse outside the intended context.

In still further embodiments, the coordination element performs mutual validation between BOT participants before a link is executed, enforces a time-bounded validity window for link execution, enforces scope restrictions to limit data exposure, and destroys temporary memory used for authorization after completion or anomaly.

In yet further embodiments, the system records a verifiable record of procedure completion while avoiding unnecessary retention of sensitive payload data.

The disclosed security improvements are integrated into the original orchestration framework: the helper BOT architecture, BOT libraries, recipe generation, procedure sequencing, and user-facing embodiments remain intact, while security is improved by link-scoped authorization, intent-consistent execution, validity window enforcement, and credential disposal.

In non-limiting embodiments, with further elaboration, the disclosed inventive system improves the functioning of computers and distributed computing environments by providing an intent-bound, link-scoped orchestration mechanism for executing multi-step workflows across heterogeneous services. The system captures user intent in a service request object (SCR object) containing the user's original time-stamped intent and intent text, derives an intent hash, and generates a recipe executable as a dependency graph of stateless jobs. Prior to executing each link, the system validates entitlements and intent consistency and issues per-link, ephemeral authorization material having constrained scope and validity. These mechanisms reduce authorization overbreadth and replay, reduce unintended tool invocation and side-effect duplication during retries, improve deterministic progression through checkpoints, and improve fault tolerance and recoverability while producing a machine-verifiable completion and audit record for the executed workflow.

### BRIEF DESCRIPTION OF THE DRAWINGS

The accompanying drawings, where provided, are incorporated in and form a part of this specification. The drawings illustrate embodiments of the invention and, together with the description, explain the principles of the invention. The drawings are illustrative and not limiting.

FIG. 1 is a block diagram of a system architecture including a helper agent, a secure orchestration engine, and distributed BOTs, showing the policy store, algorithm registry, case memory, credential module, and ledger/attestation sink.

FIG. 2 is a flow diagram illustrating control flow from intent parsing to recipe generation, per-link ephemeral credential issuance, authenticated execution, zeroization, a recursive loop across links, and termination with revocation and ledger write.

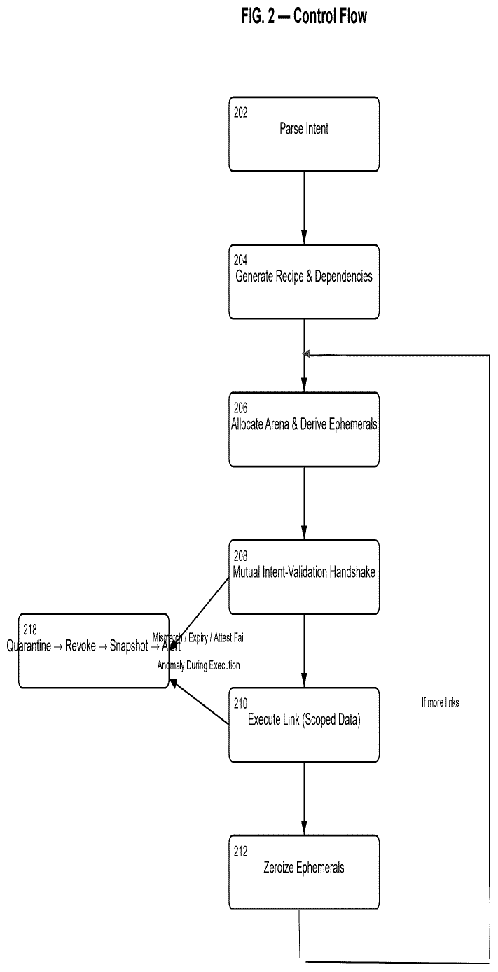

FIG. 3 is a message-sequence diagram of a per-link handshake showing ephemeral key exchange, session-key derivation, mutual intent-validation (including intent_hash, interface_id, link_id, counter, t_expiry), optional attestation, and payload transfer.

FIG. 4 is a block diagram of a case-memory learning loop capturing execution context and outcomes, updating policies/time budgets/routes, and biasing future recipe selection.

FIG. 5 is a record layout of a verifiable ledger entry containing a workflow identifier, timestamps, a Merkle root of per-link headers, and a proof artifact.

FIG. 6 is a block diagram illustrating a stored, reusable healthcare recipe library that chains stateless BOT jobs to process inputs from healthcare data sources and produce outcomes including closed-loop referrals, discharge follow-up completion, care-gap closure, and audit trails.

### DETAILED DESCRIPTION OF THE INVENTION

The terms defined in the following paragraphs are for illustration purposes and should not be construed in any way as limited the scope of the present invention.

“BOT” refers to an automated software component that validates, organizes, summarizes, creates abstractions, aggregates, classifies, filtrates, prioritizes, calculates, otherwise creates, disseminates, or otherwise processes data, as originally disclosed.

The term “Helper Agent” refers exclusively to the avatar interface and persona presented to the user (customized Helper Agent).

“User interface” includes conversational interfaces and avatar embodiments configured to receive user directives and present results.

“Coordination element” refers to a component that interprets a user directive, selects BOT participants, synthesizes a procedure, and coordinates execution.

“Procedure” refers to an ordered set of action steps synthesized by the coordination element to fulfill a user directive.

“Recipe” refers to a machine-readable representation of a procedure identifying ordered links, execution metadata and BOT participants.

“Link” refers to an action step in a recipe including a BOT-to-BOT exchange (procedure call, API call, or sub-operation)—one directed interaction defined by the recipe between a source BOT and a target BOT.

“Scope” refers to one or more limitations placed on a link, including limitations on what data may be used and what operations may be performed.

“Temporary authorization material” refers to short-lived tokens, keys, certificates, or equivalent data enabling an authorized interaction for the duration required to complete a link.

“Short-term memory” and “long-term memory” refer to storage elements that may retain recent or prior cases, procedures, or results for future assistance.

“Quarantine” refers to a state in which the engine blocks further links, revokes all active credentials, snapshots forensic context, and emits an alert.

“Network-adaptive expiry” refers to t_expiry=t_start+op budget+Δt_latency+Δt_clock, where Δt_latency as computed from recent round-trip measurements and Δt_clock is a drift allowance.

“Structured intent” refers to a machine-readable representation of a user directive expressed in a defined format (for example, a set of fields for goal, parameters, entities, constraints, and context) that can be converted into a consistent, canonical byte sequence (Enc(·)) so that the same intent always produces the same representation for processing and verification.

“Policy set” refers to a machine-readable set of rules and/or scope constraints applicable to a workflow or link, including permitted operations, data access restrictions, and execution conditions, deterministically serializable by Enc(·).

“Nonce” refers to a per-workflow random value used to ensure that identical intent and policy inputs produce different intent hashes across workflow instances; for example, a 128-bit randomly generated value.

“Intent hash (IHash)” refers to a cryptographic digest computed over a canonical encoding of (i) a structured intent representation, (ii) an applicable policy set, and (iii) a per-workflow nonce. Example: IHash=H(Enc (structured_intent)∥Enc (policy_set)∥nonce), where H is a cryptographic hash function (e.g., SHA-256), Enc(·) is a deterministic/canonical serialization, II denotes concatenation, and nonce is a random value (e.g., 128 bits) unique to a workflow instance.

“Dependency graph” refers to a directed graph representation of a recipe in which nodes represent links (and/or intermediate outputs) and directed edges represent prerequisite relationships such that a downstream link is not eligible for execution until one or more upstream links have completed and produced required outputs. In non-limiting embodiments, the orchestration engine uses the dependency graph to determine next-ready links, enforce ordering constraints, and execute links sequentially, in parallel, or recursively as permitted by policy and entitlements.

“SCR object” refers to a Service Request Object that stores the user's original timestamped intent and the intent text. In non-limiting embodiments, the SCR object is created at or near intent capture (e.g., by the user interface and/or coordination element), and the timestamped intent and intent text are inputs used to create (directly or indirectly) an intent hash for binding authorization and validating purpose-consistent link execution.

A user interacts through a customizable personal assistant in the form of an avatar—also referred to as a Helper Agent, that produces structured intent data and user-visible responses but does not handle credentials.

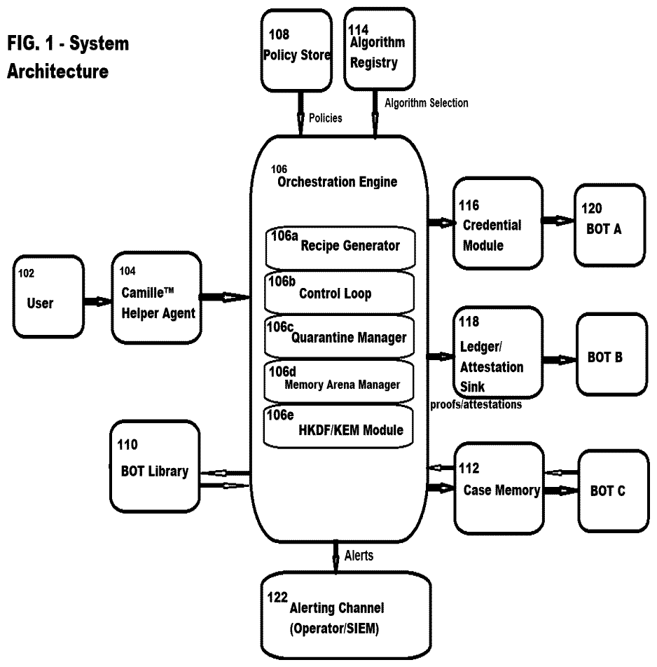

The orchestration engine depicted in FIG. 1. comprises, the orchestration engine comprises: (a) a recipe generator; (b) a credential module; (c) a policy store; (d) a BOT library registry; (e) a case memory; (f) an algorithm registry; and (g) a ledger/attestation sink. More specifically, FIG. 1 depicts the user (102) interacting with the helper agent (104), which outputs structured intent to the orchestration engine (106). Within orchestration engine (106), the recipe generator (106a) builds a machine-readable recipe; the control loop (106b) executes ordered links; the quarantine manager (106c) handles anomalies; the memory arena manager (106d) allocates page-locked volatile arenas; and the HKDF/KEM module (106e) derives per-link keys. The engine consults the policy store (108), BOT library (110), case memory (112), and algorithm registry (114), issues credentials via the credential module (116), writes proofs to the ledger/attestation sink (118), and coordinates distributed BOTs (120). Alerts flow to the operator channel (122).

The engine receives structured intent, generates a recipe, executes links sequentially or per dependency graph, and finalizes workflow state.

### A. Hardware and Implementation Environment

In one embodiment, the personal helper BOT system is implemented on one or more computing units. The computing unit may be a personal computer, server, mobile device, tablet, embedded device, or other programmable computing apparatus capable of executing instructions.

Referring to FIG. 3400 of the prior disclosure, in one embodiment a computing unit comprises: (a) one or more processors; (b) a memory system comprising volatile memory and non-volatile memory; (c) one or more storage devices; (d) one or more network interfaces; and (e) one or more input/output components for receiving user input and presenting user-visible outputs.

In another embodiment, the user interface described herein (including avatar embodiments) executes on a user device and communicates with the coordination element executing locally or remotely. In still another embodiment, the user interface and coordination element execute on the same computing unit.

In a further embodiment, the system includes a communication element enabling invocation of BOTs by local calls, remote procedure calls, RESTful calls, and/or utilization of APIs. BOTs may execute on the same computing unit as the coordination element, or on separate computing units connected over one or more networks.

A preferred embodiment may also include a system with one or more registries and libraries, including a BOT library, a procedure library, a case memory, and/or a digital library architecture. Such elements may be stored in non-volatile storage and cached in volatile memory during execution.

In one embodiment, the system includes an authentication element within and electronically connected to the computing unit that can confirm a user's identity and/or confirm authorization for executing a procedure or one or more links. The authentication element may comprise, without limitation, passwords, biometric mechanisms, device-based mechanisms, cryptographic keys, secure storage, or combinations thereof.

In further embodiments, the computing unit includes a secure execution environment configured to protect temporary authorization material used during procedure execution. Such environment may comprise, without limitation, a secure enclave, trusted execution environment, hardware security module, secure co-processor, or other protected execution/storage mechanism.

Another further embodiment includes a system with volatile memory for temporary authorization material, including a designated memory arena reserved for link-scoped authorization material during execution of a link. In one embodiment, said arena is released and destroyed after link completion.

In still further embodiments, the system can reduce persistence of sensitive data by destroying temporary memory used for authorization material after use, including by overwriting memory contents and/or employing memory protection mechanisms such as page locking, restricted access, and prompt deallocation.

In one embodiment, the system includes one or more timing sources and/or clocks. Timing may be used to enforce validity windows for link execution and to detect anomalies including late or replayed exchanges. The system may account for network latency and clock drift across devices.

In one embodiment, the system includes logging and audit components configured to record system events, procedure execution status, anomaly triggers, and verifiable completion records. In preferred embodiments, such records avoid unnecessary retention of sensitive payload data.

### B. System Architecture and Continuity to Prior Disclosure

Referring to FIG. 3400 of the Prior Disclosure, in one embodiment the system comprises a user interface (including avatar embodiments), a coordination element, a BOT library, and a communication element for invoking one or more BOT participants.

The present invention is an improvement within a personal helper BOT system that coordinates specialized BOTs to fulfill user directives. The original architecture is preserved: the coordination element receives a directive, selects BOT participants from a library, synthesizes a procedure, and returns user-visible results via the user interface.

The improvements described herein primarily concern how authorization and security are handled during procedure execution, particularly across BOT-to-BOT interactions and external service calls, while maintaining compatibility with existing embodiments including avatars, case-based reasoning, and digital library elements.

### C. Procedure/Recipe Generation and Execution

Referring to FIG. 3401, in one embodiment the coordination element receives a user directive and interprets the directive to determine an intended goal and constraints.

In this embodiment, the coordination element synthesizes a procedure comprising one or more action steps, selects one or more BOT participants, and invokes said BOT participants to perform the action steps.

In a further embodiment, the procedure is represented as a recipe comprising ordered links. Each link identifies one or more BOT participants, an action to be performed, and optional constraints including scope restrictions and timing constraints.

In still another embodiment depicted in step 6 of FIG. 3401, for Multi BOT Recipes, the orchestrated execution proceeds link-by-link. After completion of one link, results may be provided as input to a subsequent link. This process continues until the procedure terminates and the requested service or work product is delivered to the user. A preferred embodiment may also have the coordination element that executes with a control loop in the recipe iteratively or recursively until completion, including where links depend on prior link completion status.

In accordance with the security model described in the incorporated prior applications, BOT execution is governed by security entitlements defining permissions, rights, restrictions, and levels of security associated with BOT identity, authorized functions, data access scope, and operational boundaries. In such prior embodiments, entitlement validation establishes a first level of security by confirming authenticated identity and privilege authorization prior to execution. In the embodiments described herein, that entitlement-based model is preserved and extended through intent-bound verification, wherein an intent hash derived from structured intent is incorporated into credential generation and link validation. The intent hash introduces an additional level of security that confirms not only that a BOT is authenticated and entitled to act, but that the specific operation being executed corresponds to the authorized purpose of the workflow. Accordingly, the disclosed orchestration engine maintains continuity with earlier entitlement-based security frameworks while augmenting them with purpose-bound validation that constrains execution to intended context and mitigates misuse of otherwise valid credentials.

### D. Authentication and Security Improvements (Further Embodiments)

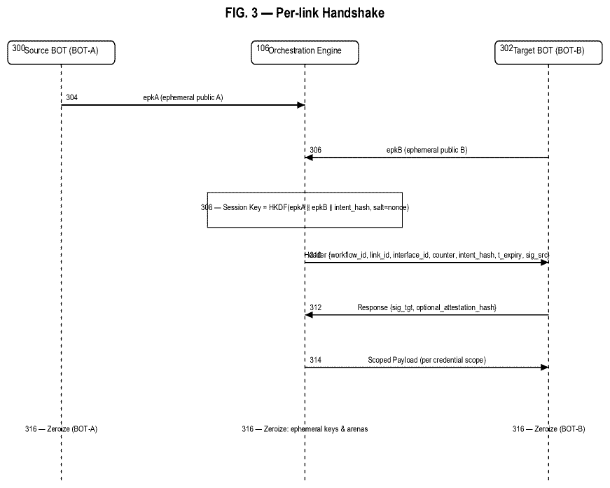

Referring to FIG. 3, in further embodiments the system establishes link-scoped authorization material prior to executing a link, executes the link under scope and timing constraints, and destroys temporary authorization material after completion or anomaly.

In further embodiments, the system includes an authentication element within and electronically connected to the computing unit that can confirm a user's identity and/or confirm authorization for executing a procedure or one or more links within a procedure.

In further embodiments, the coordination element establishes temporary authorization material for each link, such authorization material being valid only for that link and being destroyed after completion or anomaly. Such temporary authorization material may include, without limitation, temporary tokens, temporary keys, temporary certificates, and/or other temporary data sufficient to enable an authorized interaction for the duration required to complete the link.

In another preferred embodiment, the temporary authorization material is bound to (i) a user directive, (ii) a recipe context, and (iii) a link identifier. In this manner, authorization is purpose-bound and cannot be readily reused across unrelated actions or time windows.

In still further embodiments, prior to link execution, participating BOTs perform mutual validation to confirm that the link to be executed is consistent with the procedure being performed and constraints applicable thereto. If mutual validation fails, the coordination element halts execution and may enter a quarantine state as described below.

In still further embodiments, the coordination element enforces a time-bounded validity window for each link. The validity window may be selected based on expected operation duration and network conditions. If a link is attempted outside the validity window, the link is not executed.

In still further embodiments, temporary memory used to store temporary authorization material is destroyed after completion of a link, including by overwriting such memory and/or releasing said memory from use.

### E. Mutual Validation and Link Context Consistency (Further Embodiments)

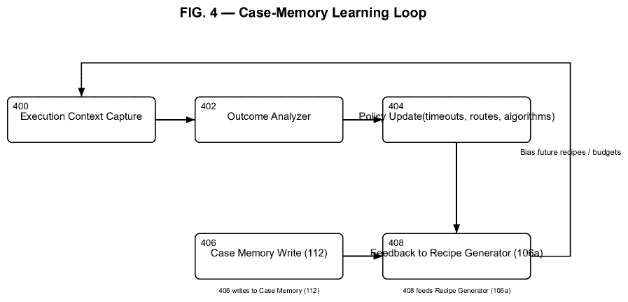

Referring to FIG. 4, in further embodiments, participating BOTs perform a mutual validation exchange prior to link execution. In one embodiment, mutual validation includes confirming that both sides agree upon link context metadata including at least: a link identifier, a directive-consistent intent hash representation, participating BOT identifiers or roles, and a validity window.

In one embodiment, mutual validation includes a monotonically increasing counter or other ordering element to reduce replay risk and to ensure that links are executed in an expected order.

In another embodiment, mutual validation may include signature checks, interface authorization checks, and/or confirmation that the link action is permitted under policy constraints.

### F. Scoped Execution and Minimum Necessary Data (Further Embodiments)

In further embodiments, each link may be executed under one or more scope restrictions. Scope restrictions may specify, by way of example, what fields of data may be used, what operations may be performed, where data may be transmitted, and which BOTs or services may be involved.

In one preferred embodiment, BOT participants receive only the minimum necessary data required to complete the link, thereby reducing exposure of sensitive information across BOT boundaries.

In another embodiment, scope restrictions may be enforced at the coordination element, at individual BOT participants, and/or at a gateway managing calls to external services.

### G. Quarantine and Revocation (Further Embodiments)

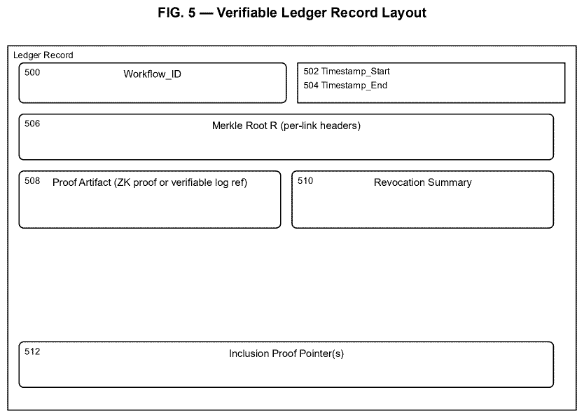

Referring to FIG. 5, in further embodiments the system includes a quarantine state. In some embodiments, the system commits execution-relevant assertions to a Merkle tree and binds a Merkle root to a link authorization artifact (e.g., a signed token, session record, or other commitment) such that the authorized execution context is cryptographically fixed. An anomaly may include, without limitation: (i) a mismatch in mutual validation, including a failure to verify a Merkle proof for a mutual-validation artifact against the bound Merkle root; (ii) an attempt to execute a link outside an associated validity window, including where validity parameters committed as one or more Merkle leaves indicate the link is not currently valid; (iii) a detected policy violation, including where a policy version, policy hash, or policy assertion fails Merkle proof verification or conflicts with the bound Merkle root; or (iv) suspicious execution conditions, including where one or more execution-condition assertions fail Merkle proof verification, are missing required proofs, or otherwise deviate from the Merkle-committed execution context.

In quarantine, the coordination element blocks subsequent links, revokes temporary authorization material, destroys temporary memory used for authorization, and may record diagnostic context sufficient to analyze the anomaly.

In further embodiments, after procedure completion, the system revokes any remaining temporary authorization material associated with the procedure.

### H. Verifiable Completion Record (Further Embodiments)

Referring to FIG. 5, in further embodiments the system records a verifiable record of completion of a procedure or one or more links. The record may include identifiers, timestamps, counters, and other metadata sufficient to demonstrate that procedure execution occurred within applicable constraints.

In one embodiment, the verifiable record is configured to avoid retention of sensitive payload data. In one embodiment, the record comprises a cryptographic commitment over per-link metadata (e.g., a digest, accumulator, or Merkle root over per-link header values).

In still further embodiments, the verifiable record may be accompanied by proof sufficient to demonstrate compliance with one or more constraints (e.g., ordering of links and validity windows) without disclosing underlying payload data.

### I. Optional Technical Deepening (Still Further Embodiments—Non-Limiting)

In still further embodiments, temporary authorization material for a link may be derived from ephemeral key pairs generated in volatile memory and may be bound to a directive-consistent representation of intent. In one embodiment, a shared session key may be computed as a function of public keys and an intent representation (e.g., an “intent hash”) and used to authenticate link communications for the duration of the link.

In one embodiment, the system may account for network latency and clock drift when selecting a validity window. In one embodiment, an expiry value may be derived from an operation budget, a measured or estimated latency bound, and a clock drift bound.

In one embodiment, temporary authorization material is destroyed after use, including by overwriting and/or releasing a designated volatile memory arena. In one embodiment, memory arenas may be page-locked or protected to reduce unintended persistence.

In one embodiment, the system may employ algorithm agility by selecting cryptographic mechanisms under policy, including classical and/or post-quantum options, without departing from the recipe-based orchestration framework.

In one embodiment, the system may verify attestation or execution integrity information from a BOT participant or execution environment prior to releasing sensitive payload data required for a link.

### J. Case Memory and Learning (Non-Limiting)

In one embodiment FIG. 4, short-term memory is engaged by keeping recently executed procedures in local memory of the current session or in a short-term cache. Long-term memory may be engaged so that successfully fulfilled directives are remembered using case-based reasoning techniques: case-memory learning loop capturing execution context and outcomes, recalled, replayed, adapted, and resaved with new indices, including indices related to user preferences, updating policies/time budgets/routes, and biasing future recipe selection.

In one embodiment, case memory may bias subsequent procedure synthesis. However, in preferred embodiments, such bias does not replace the security constraints described herein: link-scoped authorization, mutual validation, validity windows, scope restrictions, and destruction of temporary authorization material remain in effect.

### EXAMPLE EMBODIMENTS (NON-LIMITING)

In non-limiting embodiments, the disclosed orchestration engine provides one or more of the following computer- and network-level improvements: (1) least-privilege execution at link granularity: per-link ephemeral authorization material constrained by scope and time, limiting blast radius and reducing replay risk; (2) purpose-bound execution: intent validation using an intent hash derived from an SCR object (including the user's original timestamped intent and intent text) to prevent purpose drift across multi-step automation; (3) deterministic multi-step progress in distributed systems: dependency-graph gating and checkpointing that constrain ordering, control parallelism, and enable safe continuation after partial failures; (4) reduced duplicate side effects: verification and idempotency controls that prevent repeated external actions (e.g., double submissions, repeated updates) under retries and transient errors; and (5) improved auditability without persistent sensitive payload retention: generation of a verifiable completion record that cryptographically/structurally links the authorized request to executed links and their verified milestones. These improvements arise from specific technical mechanisms described herein and are not limited to any particular domain (e.g., music, genealogy, and healthcare), even when example embodiments are presented in those contexts.

Accordingly, the disclosed improvement is not premised on a hypothetical “end-to-end” domain-specific computer, but rather on improvements to conventional distributed workflow execution and authorization models by introducing intent-bound, link-scoped execution control that enables safe, verifiable composition of stateless tasks across heterogeneous services.

### Example 1: Music Playlist Curation

In one non-limiting embodiment, the system is used to assist an artist in identifying relevant curated playlists for a song. The coordination element may invoke one or more BOTs to analyze song properties, generate one or more feature representations, identify candidate playlists, evaluate compatibility between the song and playlists, and prepare a report for the user.

In one embodiment, the system further invokes one or more BOTs to evaluate playlist freshness and detect suspicious behavior indicating fraud. Candidate playlists may be stored in an approved directory and/or a rejected directory based on evaluation rules.

In one embodiment, the system remembers prior successful submissions and outcomes as cases, thereby reducing repeated external calls and improving future recommendations.

### Example 2: Research Embodiment

In one non-limiting embodiment, the system is used to assist in multi-source Genealogy research by coordinating one or more BOTs to securely retrieve private records from disparate data stores, extract relevant attributes, detect conflicts, rank evidence, and generate a user-visible summary.

Domain-specific BOT class taxonomies and internal classifications, if any, are illustrative only and may be omitted or abstracted without departing from the invention.

### Example 3: Healthcare Embodiment

In one non-limiting embodiment, the system is configured to coordinate healthcare workflows involving protected, regulated, or otherwise sensitive data while enforcing link-scoped authorization, intent-bound validation, validity windows, and scope restrictions. A user may submit a healthcare service request through a user interface that produces structured intent and an SCR object containing the user's original timestamped intent and intent text. The orchestration engine generates a recipe comprising ordered links and/or a dependency graph, selects BOT participants, and executes links only when entitlement validation and intent validation succeed. Per-link authorization material is issued for each link and destroyed after completion or anomaly, and a verifiable completion record may be written while avoiding unnecessary retention of sensitive payload content.

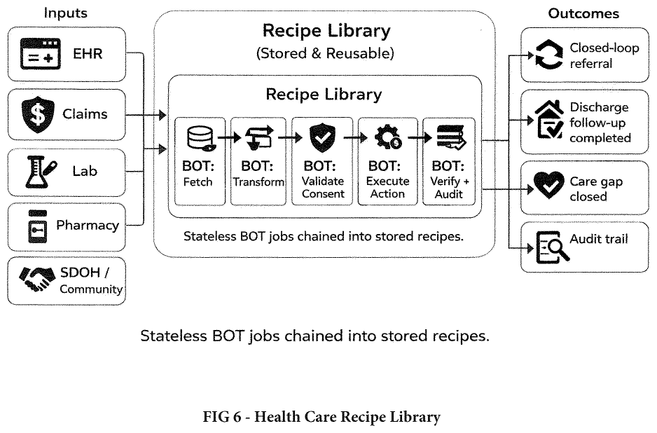

FIG. 6 illustrates a non-limiting architecture in which reusable healthcare recipes are stored as dependency graphs of chained stateless BOT jobs, where each job executes only after intent-bound validation and link-scoped ephemeral authorization succeed, and where completion is verified at milestones to produce a machine-verifiable audit record. More specifically, FIG. 6 illustrates a stored and reusable healthcare recipe library in which stateless BOT jobs are chained to transform inputs from healthcare data sources including, without limitation, electronic health record (EHR) systems, claims systems, laboratory systems, pharmacy systems, and/or social determinants of health (SDOH) or community-resource systems. In the illustrated sequence, a fetch BOT retrieves scoped data, a transform BOT normalizes or maps data into an internal representation, a validate-consent BOT confirms patient consent and/or policy compliance for the requested operation, an execute-action BOT performs an authorized downstream action (e.g., scheduling, referral submission, prior-authorization assembly, or care-plan update), and a verify-and-audit BOT confirms completion and records an audit trail. In non-limiting embodiments, the recipe library stores such chained BOT jobs as reusable recipes with dependencies, enabling closed-loop referrals, discharge follow-up completion, care-gap closure, and auditable workflow outcomes under intent-hash binding derived from the SCR object.

### System Architecture and Roles

A user may interact through an avatar, which produces structured intent but does not handle credentials. The orchestration engine comprises:
recipe generator,
security entitlement module,
credential module,
policy store,
BOT registry,
case memory,
algorithm registry,
ledger/attestation sink.

The engine executes recipe links according to dependency graphs while enforcing both entitlement security and intent-bound validation.

### Concrete Mechanisms

For each link, the engine allocates page-locked volatile memory and derives ephemeral keys.

### Session Key:

K=HKDF-SHA256(epkA_pub II epkB_pub II intent_hash, salt=handshake nonce)

Entitlement validation confirms that the BOT possesses permissions required for the requested operation.

Intent validation confirms the operation matches the structured intent represented by the intent hash.

Handshake includes: {workflow_id, link_id, interface_id, counter, intent_hash, t_expiry, sig_src}

Replay prevention uses monotonic counters; expired links fail closed. Data minimization releases only fields allowed by security entitlements. On completion or anomaly, volatile arenas are zeroized. Quarantine triggers on signature mismatch, entitlement failure, intent mismatch, or expiry violations.

### Control Flow

Receive structured intent. Generate recipe with dependencies. For each link:
allocate arena
derive ephemeral credentials
validate entitlements
validate intent hash
execute scoped operation
zeroize memory

Repeat recursively until workflow completion. Revoke remaining credentials and write verifiable ledger record.

### EXAMPLE EMBODIMENTS

Enterprise document processing pipeline where each BOT receives only entitlement-authorized data fields and link-specific intent validation. Financial BOT execution where entitlement criteria define transaction limits and intent hash confirms operation purpose.

### INDUSTRIAL APPLICABILITY

The invention applies to personal helper systems, enterprise automation, distributed computing, multi-agent orchestration, digital libraries, and secure execution of procedures across multiple services.

### Appendix (Illustrative Pseudocode)

In one embodiment, procedure execution may be performed iteratively or recursively, for example:

```
def exec_recipe(recipe):
  if recipe.complete( ):
    return finalize( )
  link = recipe.next_ready( )
  # establish temporary authorization for the link
  arena = alloc_volatile_arena( )
  creds = derive_temp_link_credentials(link, recipe.context)
  if not validate_link_context(link, creds):
    quarantine( )
    zeroize(arena)
    return finalize( )
  execute_link(link, creds)
  zeroize(arena)
  return exec_recipe(recipe)
```

The foregoing descriptions are provided for purposes of illustration and description and are not intended to be exhaustive or limiting. Many modifications and variations will be apparent to those of ordinary skill in the art. Many more providers of digital content will be offering their own BOT virtual assistants and “smart” apps offering services that mirror how you would interact with a sales assistant that already knows you very well and thus would be able to recommend or advise you on products and services. BOT empowered searches have increased depth and breadth by direct access to libraries of digitized multimedia content in addition to the World Wide Web and the obvious database of TV programs or movies native to the Cable TV embodiment. These searches are customized based on preferences provided by the searcher and assisted by a wizard at creation time, also allowing for customization of search results and their integration into living documents such as reports, spreadsheets, and/or business presentations, etc. These searches can be reversed, bringing about alerts that can be extremely timely and helpful to people that use this feature. All alert information and task completion status information from helper BOTs can be delivered by the avatar or directly by email, text, smart phone applications all integrated by one entertainment operating system and delivered on your flat screen television, gaming interface, laptop, tablet, car dashboard interface, or smart phone. Alternative mechanisms providing equivalent security functions may be substituted without departing from the scope of the claims. Furthermore, the foregoing descriptions of the present invention are not intended to be exhaustive or to limit the invention to the precise forms disclosed. Many modifications and variations will be apparent to the practitioner of ordinary skill in the art.

In addition, in various embodiments, the helper BOTs of the present invention provide a believable personal assistant in the form of a customizable avatar that the user may find much more socially inviting and more like a companion and/or a real person that they may talk to and simply ask for help. The user can engage in forms of conversational dialogue with the avatar using any of a number of available input and output mechanisms, such as for example speech, gaming interfaces, graphical user interfaces, text entry, car dashboard interfaces and the like. The BOT system can be implemented using any of a number of different platforms, such as device API's, the web, email, gaming interfaces, TV based browsers, digital media receivers, new entertainment enabling operating systems and the like, or any combination thereof. The embodiments were chosen and described in order to best explain the principles of the invention and its practical application, thereby enabling others of ordinary skill in the art to understand the invention for various embodiments and modifications suited to the particular use contemplated.

1. A secure orchestration engine executed by one or more processors, comprising:
a helper-agent interface to receive structured intent;
a recipe generator to produce a machine-readable recipe of ordered links between BOTs;
a security entitlement module configured to enforce security entitlements defining rights, restrictions, and levels of security associated with BOT identity, access privileges, data scope, or operational constraints;
a credential module configured, for each link, to:
(i) allocate a volatile memory arena;
(ii) derive ephemeral key pairs and a shared session key as a function of public keys and an intent hash;
(iii) set a network-adaptive expiry;
(iv) perform mutual intent-validation including entitlement checks;
(v) execute only data/functions permitted by entitlements;
(vi) zeroize ephemeral key material upon completion or anomaly;
a control loop to repeat execution across links; and
a revocation module to revoke credentials and emit proof of completion, wherein validation of the intent hash constitutes an additional level of security beyond identity-based entitlement authorization by verifying correspondence between execution purpose and authorized intent.

2. The engine of claim 1 wherein the session key is computed by HKDF over a concatenation of the public keys and the intent hash.

3. The engine of claim 1 wherein the network-adaptive expiry is t_expiry=t_start+op budget+Δt_latency+Δt_clock.

4. The engine of claim 1 wherein the mutual intent-validation requires matching {intent_hash, interface_id, link_id, counter, t_expiry}.

5. The engine of claim 1 further comprising a quarantine state that blocks subsequent links, revokes active credentials, snapshots forensic context, and emits an alert.

6. The engine of claim 1 wherein key material is allocated in page-locked memory and erased via constant-time overwrite.

7. The engine of claim 1 wherein the engine verifies a remote attestation report for a target BOT before releasing payload.

8. The engine of claim 1 wherein the verifiable proof of completion comprises a Merkle root over per-link headers and zero-knowledge proof attesting compliance with counter monotonicity and expiry bounds.

9. The engine of claim 1 wherein case memory updates bias subsequent recipe generation.

10. The engine of claim 1 wherein algorithm selection supports classical and post-quantum primitives via a registry.

11. The engine of claim 1 wherein replay resistance is enforced by a per-workflow monotonic counter embedded in each handshake.

12. The engine of claim 1 wherein the helper agent is logically isolated from credential handling and communicates only structured intent and user-visible results.

13. A method comprising:
receiving structured intent;
generating a recipe for each link deriving ephemeral keys in volatile memory;
computing a session key from public keys and an intent hash;
authenticating and executing the link within a network-adaptive expiry;
zeroizing keys on completion or anomaly;
repeating for subsequent links; and
recording verifiable proof of completion with revocation of residual credentials.

14. A non-transitory computer-readable medium storing instructions that, when executed, perform the method of claim 13.

15. The engine of claim 1 wherein each BOT receives only the minimum data fields enumerated in the credential's scope.

16. The engine of claim 1 wherein security entitlements specify permissions associated with BOT intrinsic characteristics including identity, associated service, permitted functions, and data scope.

17. The engine of claim 1 wherein levels of security comprise:
(a) a first level validating BOT identity and entitlement privileges; and
(b) a second level validating an intent hash associated with workflow purpose.

18. The engine of claim 1 wherein entitlement validity requires matching the requested operation with the intent hash of the link.

19. The engine of claim 1 wherein temporary execution data is destroyed after link completion.

20. The engine of claim 1 wherein BOT execution forms chained loops governed by entitlement validation and intent-bound authentication.
